(19) United States
(12) Patent Application Publication
(10) Pub. No.: US 2017/0254689 A1
(43) Pub. Date: Sep. 7, 2017

(54) Rigid Container for Precision Liquid Measuring and Dispensing

(71) Applicant: Mohawk Innovations Limited, Dublin (IE)

(72) Inventor: Sarah Pavis, Brooklyn, NY (US)

(73) Assignee: Mohawk Innovations Limited, DUBLIN (IE)

(21) Appl. No.: 15/599,079

(22) Filed: May 18, 2017

Related U.S. Application Data
(60) Provisional application No. 62/484,803, filed on Apr. 12, 2017.

(51) Int. Cl. G01F 11/28; B65D 47/06; G01F 15/00

(52) U.S. Cl. CPC G01F 11/28; G01F 15/005; B65D 47/06

(57) ABSTRACT

This invention teaches dispensing a precise amount of liquid from a rigid vessel using a combination of valves, plugs, and diaphragms. In particular, a rigid container with a connected measuring receptacle can dispense oil. A user can depress at least one diaphragm on the rigid container to pressurize a chamber, forcing the liquid upwards into a hollow tube and into the measuring receptacle. The hollow tube, traversing the interior of the container, has at least one orifice at both the proximal and distal ends. The user can calibrate the amount of liquid in the measuring receptacle by activating a release valve or stopper to remove the liquid from the measuring receptacle and back into the container. In addition, a flexible and optionally removable lid covers the measuring receptacle. This lid can be depressed to pressurize the measuring receptacle and expel the liquid from an orifice on the measuring receptacle.

### PRIORITY CLAIM

This application claims priority to U.S. Provisional Patent Application Ser. No. 62/484,803 filed on Apr. 12, 2017, entitled “Rigid Container for Precision Liquid Measuring and Dispensing,” the disclosure of which is hereby incorporated by reference.

### FIELD OF INVENTION

The present invention relates to the field of gaskets and valves. In particular, this invention teaches extracting fluid from a first vessel into a measuring receptacle using a combination of valves, plugs, and diaphragms. In addition, this invention teaches enabling the extracted fluid in the measuring receptacle to flow back into the first vessel using a combination of valves, plugs, and diaphragms without wasting or contaminating any of the fluid.

### BACKGROUND OF THE INVENTION

The kitchen goods industry has a myriad of devices to assist with food preparation and improve food sanitation. In addition, these devices help reduce food waste and make it easier for chefs to use precise amounts of food/liquid as called for in specific recipes and/or diets.

Oil dispensers are used to assist chefs in accurately measuring the amount of cooking oil needed before pouring it out of an oil bottle. This reduces any waste and prevents the chef from using too much or little oil in the food preparations.

The present invention teaches an improved dispensing device for extracting cooking oil or other liquids from a first vessel into a second vessel. In addition, the present invention teaches being able to dispel or pour the liquid from the second vessel, in a controlled manner, onto food stuffs, serving, or cooking dishes. Further, this invention teaches a device capable of removing the cooking oil or other liquid from the second vessel and siphoning it back into the first vessel without spilling liquid, using a secondary device, or requiring the chef to touch the oil, liquid, or other fluid stuff

### DESCRIPTION OF PRIOR ART

In U.S. Pat. No. 8,579,164 (entitled “Dispensing Bowl Attachment for Use with a Bottle”), Sanguinet, et al. teach a bowl attached to a bottle for dispensing fluid. However, Sanguinet, et al. fail to teach precisely measuring the amount of fluid in the bowl before dispensing the fluid onto foodstuffs or a cooking vessel, or siphoning all or a portion of the fluid back into the original bottle.

In U.S. Pat. No. 5,330,081, (entitled “Measuring Dosage Dispenser”), Davenport teaches a portion measuring device for fluids. However, Davenport fails to teach a first reservoir is rigid and instead teaches away that the first reservoir is flexible.

In U.S. Pat. No. 6,253,967 (entitled “Assembly Comprising a Flexible Container Having a Dosing Device and Dosing Device of Such Assembly”), Welland teaches a flexible container with a dosing device for dispensing the liquid. However, Welland fails to teach a rigid container that can dispense a precise amount of liquid.

In U.S. Pat. No. 5,833,124 (entitled “Fluid Dispensing Device”), Groves, et al. teach a “fluid dispensing device which is used to measure [a] desire[d] amount of fluid from a bottle, such as a deformable resilient plastic bottle, and dispense that measured amount.” However, Groves, et al. fail to teach rigid dispensing device.

### SUMMARY OF THE INVENTION

This invention teaches a receptacle capable of containing a liquid, preferably cooking oil that can be precisely calibrated for use in cooking. In a preferred, the receptacle has three chambers: a first bottom chamber, a second middle chamber connected to the first bottom chamber with at least two one-way valves or one two-way valve, and a third top chamber with calibrated measurement markings. In a preferred embodiment, the third chamber has an orifice or spout from which the liquid cooking oil can be pour out of. In another preferred embodiment the third chamber has a flexible lid that can be depressed to increase air pressure in the third chamber and force the liquid to be expelled from the spout in a controlled manner.

In a preferred embodiment the first, second, and third chambers are all rigid. A human user can depress two flexible portions on the second chamber. This increases the air pressure in the second chamber. As the air is pressurized in the second chamber, it can travel into the first chamber to pressurize the first chamber via at least two one way valves connecting the first and second chamber. In an alternative embodiment, the air pressurized in the second chamber can travel to the first chamber to pressurize the first chamber via at least one two-way valve. In another alternative embodiment, there is one, one-way valve that permits allows air from the second chamber to enter the first chamber to pressurize the first chamber.

A tube (or straw) traverses the interior of all three chambers in the receptacle. The tube has a distal and proximal end. The distal end terminates in the third chamber. In addition, the distal end has at least one orifice capable of allowing the liquid to enter or exit the tube. The proximal end terminates in the first chamber and has at least one orifice capable of allowing the liquid to enter or exit the tube from the first chamber. The straw may be a continuous piece that traverses all three chambers. Alternatively, the straw may be two or three separate pieces that, are connected together and sealed at their junctures.

As the first chamber is pressurized from air from the second chamber, the liquid in the first chamber is forced upward into the tube through the at least one orifice in the proximal end. The liquid then travels upward and exits the tube at the at least one orifice at the distal end of the tube and enters the third chamber.

Calibrated markings on the side of the third chamber alert a user as to precisely how much liquid is in the third chamber. If the user desires, the liquid can then be poured out of the third chamber by tilting the receptacle and pouring the liquid out of the spout connected to the third chamber. In an alternative embodiment, a user is capable of depressing the flexible lid on the top of the third chamber, thereby increasing the pressure in the third chamber.

An actuator on the side of the second chamber is connected to stoppers. The first connecting the first and second chambers, and the second plugging an orifice in the tube in at the base of the third chamber. When the actuator is active the first and/or second plugs are activated. If the first plug is activated, pressure is released from the first chamber and thus any liquid in the straw will exit the straw at the at least one orifice at the proximal end and enter back into the first chamber. When the second plug is activated, liquid from the tube in the third chamber will exit the tube and enter the third chamber. This is useful, as a user may have needs wherein the liquid needs to be precisely measured and any excess in the tube would offset the calibrations.

The oil bottle may be easily washed by washing machine, the interior parts easy to assemble and reassemble for cleaning and maintenance purposes. In addition, in a preferred embodiment, all surfaces of the oil bottle are covered in an oliophobic substance to prevent the build-up of oil on the interior surfaces. The oil bottle may be any color or material, including but not limited to plastic, glass, metal, ceramic, and/or composite.

### BRIEF DESCRIPTION OF THE DRAWINGS

FIG. 1 shows a perspective view of the oil bottle with measuring receptacle.

FIG. 2 shows a rear view of the oil bottle with measuring receptacle with plane A-A.

FIG. 3 shows a cutaway view of the oil bottle with measuring receptacle along plane A-A.

FIG. 4 shows Detail A, the pressure chamber of the oil bottle, from FIG. 3 cutaway view along plane A-A.

FIG. 5 shows Detail B, the measuring receptacle of the oil bottle, from FIG. 3 cutaway view along plane A-A.

FIG. 6 shows a front-side view of the oil bottle with measuring receptacle with plane B-B.

FIG. 7 shows, a cutaway view of the oil bottle with measuring receptacle along plane B-B.

FIG. 8 shows Detail C of the pressure chamber of the oil bottle from FIG. 6.

FIG. 9 shows Detail D, the pressure chamber of the oil bottle from FIG. 6 cutaway view along plane B-B.

FIG. 10 shows a side-left view of the oil bottle with measuring receptacle with loops on the flexible flaps with plane C-C.

FIG. 11 shows a cutaway side view of the oil bottle with measuring receptacle with loops on the flexible flaps along plane C-C with Detail E and plane D-D.

FIG. 12 shows Detail E, a concave duckbill flap in the oil bottle with measuring receptacle.

FIG. 13 shows a bottom section view along plane D-D of the juncture between the lower and middle chambers of the oil bottle with measuring receptacle.

FIG. 14 shows a front view of the oil bottle with measuring receptacle with loops on the flexible flaps with Detail F.

FIG. 15 shows a top view of the oil bottle with measuring receptacle.

FIG. 16 shows a side view of the oil bottle with measuring receptacle.

FIG. 17 shows Detail F, a side view of the flexible flap with orifice and loop for the oil bottle with measuring receptacle.

FIG. 18 shows a perspective view of the oil bottle with measuring receptacle with Detail G.

FIG. 19 shows Detail G, a perspective view of the flexible flap with orifice and loop for the oil bottle with measuring receptacle,

### DETAILED DESCRIPTION OF THE INVENTION

The following is a non-limiting written description of embodiments illustrating various aspects of this invention.

As used herein, the term receptacle is deemed to mean any multi-dimension container capable of containing a liquid. The term receptacle is deemed to be synonymous with a chamber, container, box, bottle, vessel, thermos, jar, and/or other type of liquid containment vehicle.

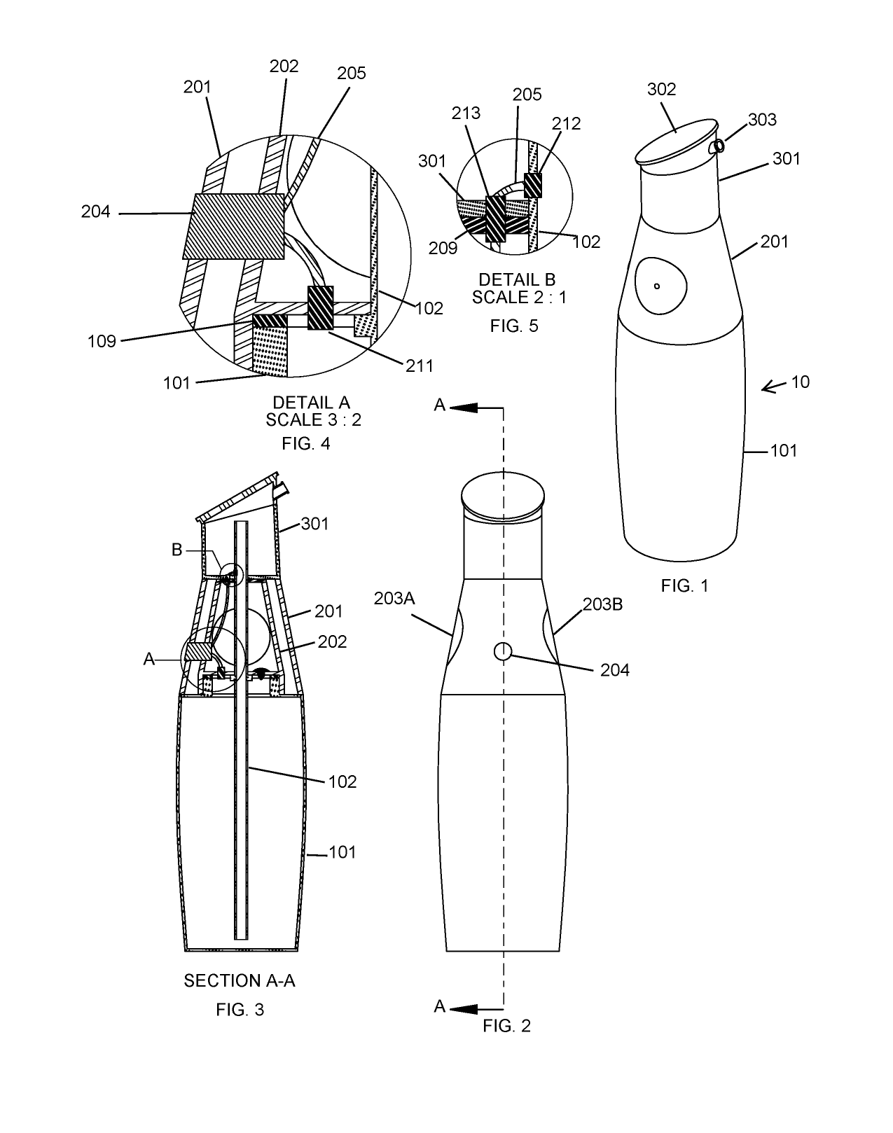

FIG. 1 shows a perspective view of a receptacle 10 with a first chamber 101, a second chamber 201, and a third chamber 301. In a preferred embodiment the first chamber 101, second chamber 201, and third chamber 301 are all rigid and do not deform when squeezed or otherwise pressed by a human hand. Liquid from the third chamber 301 can exit the receptacle 10 via spout 303. The third chamber 301 has an optionally removable and flexible lid 302 that can be depressed to increase pressure in the third chamber 301 which controllably forces the liquid in the third chamber 301 out of the third chamber 301 through the spout 303.

FIG. 2 shows a rear view of the oil bottle with measuring receptacle 10 with plane A-A. The second chamber 201 has optionally two flexible caps, 203A and 203B. Each cap, 203A and 203B, has an orifice as seen in FIG. 1. The second chamber 201 also has an actuator 204 which may be flexible or rigid.

FIG. 3 shows a cross-section at A-A of the receptacle 10. A hollow tube 102 extends through the entire length of the receptacle 10. The tube 102 may be flexible or rigid. In preferred embodiments, the tube 102 is one unbroken straw. However, in other conceived embodiments the tube 102 may be composed of multiple disparate segments sealed with gaskets and valves. The second chamber 201 has a second inner chamber created by the housing 202. When the caps 203A and 203B are pressed inward and the orifice in each cap 203A, 203B is covered (preferably with a finger thumb), the second inner chamber 202 is pressurized pushing air into the first chamber 101. The increase in air into the first chamber 101 pushes the liquid contained in chamber 101 upward into wise 102 through an orifice in tube 102. As the air pressure is increased in the second inner chamber 202 and first chamber 101, more liquid enters the tube 102. The liquid exits the tube 102 at a second orifice in the third chamber 301. To release the liquid from the third chamber 301, a user may depress cap 302 to increase pressure in the third chamber 301 and force the liquid to expel out of the third chamber 301 through spout 303. Optionally, a user may manually turn the receptacle 10 to pour the liquid out of the third chamber 301 via spout 303.

FIG. 4 shows Detail A, the second inner chamber 202 of the receptacle 10, along cross-section A-A. A flexible gasket 109 seals the first chamber 101 to the second chamber 201 and second inner chamber 202. The flexible caps 203A and 203B seal the second chamber 201 to the second inner chamber 202. Actuator 204 is connected to a first stopper 211. When the actuator 204 is activated, the first stopper 211 creating a seal between the first chamber 101 and the second inner chamber 202 is removed decreasing air pressure from the first chamber 101 (allowing air from the first chamber 101 to enter the second inner chamber 202) and allowing any liquid in the tube 102 to re-enter the first chamber 101.

Inside of the secondary pressurization chamber are one or more valves, gaskets, plugs, or flaps 210. These sealing members can be opened to link the primary and secondary chambers. They can be opened either by means of air pressure, liquid pressure, or mechanical actuation. Valves installed on the face between the two chambers may be either one way or two way. These valves can be either flap, duckbill, or umbrella. There are one or more flexible members, 203A, 203B which control the pressurization of the second chamber 201 and second inner chamber 202. In a preferred embodiment these allow the second chamber 201 and second inner chamber 202 to open to the outside environment with a thru hole or other orifice to allow for gauge pressure normalization. In alternative embodiments, the caps 203A and 203B are completely closed off to the outside environment and do not have a central orifice.

The third chamber 301 is connected to the second chamber 201, by way of one or more valves, gaskets, plugs, or flaps 213. The third chamber is separated from the second chamber 201 by flexible member 209. In a preferred embodiment flexible member 209 is a gasket.

The first chamber 101 and second chamber 201 can be a single continuously connected chamber (not shown) but in a preferred embodiment (as seen in FIG. 2) they are two or more chambers separated by valves, gaskets, plugs, or flaps.

FIG. 5 shows Detail B, the actuation system that permits liquid to exit the tube 102 into the third chamber 301 or enter the tube 102 from the third chamber 301. A flexible or rigid actuation button 204 (as seen in FIG. 2) is capable of actuating the actuation system in Detail B. The rigid or flexible actuation button 204 is capable of being activating the actuation system 205 that connects the plugs/flaps/valves/gaskets 205, 212, 213, preferably in a linkage system. In an alternative embodiment, the flexible actuation button 204 is itself a one-way or two-way valve which acts as passive actuation for the valve system 205, 212, 213. A gasket 209 joins the second chamber 201 and third chamber 301 in a static seal.

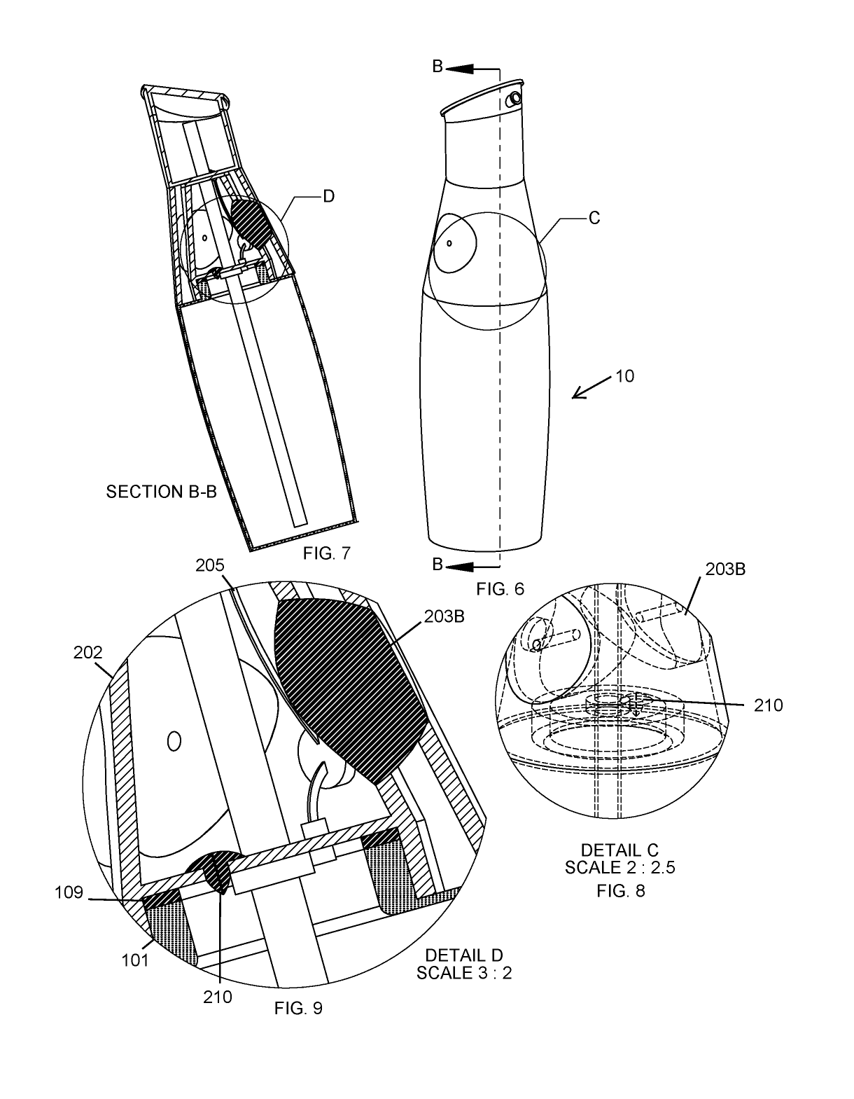

FIG. 6 shows a front-side view of the oil, bottle with measuring receptacle 10 with plane B-B. FIG. 7 shows a cutaway view of the oil bottle with measuring receptacle along plane B-B.

FIG. 8 shows Detail C (as seen in FIG. 6), the main pressure valve 210 is a valve between the first chamber 101 and second chamber 201 of the oil bottle 10. The main pressure valve 210 can allow for liquid to flow in one direction, from the second chamber 201 to the first chamber 101 or first chamber 101 to second chamber 201 or can be bidirectional, allowing liquid to flow in both directions.

FIG. 9 shows Detail D of the oil bottle 10. The first stopper 211 (as seen in FIG. 4) can be a valve, gasket, flap, and/or plug connects the first chamber 101 and second chamber 201. A second stopper 212 connects the third chamber 301 and'the tube 102. The valve/gasket/flap/plug/shaft/tube 213 connects the second chamber 201 and third chamber 301 in a dynamic seal allowing for articulation.

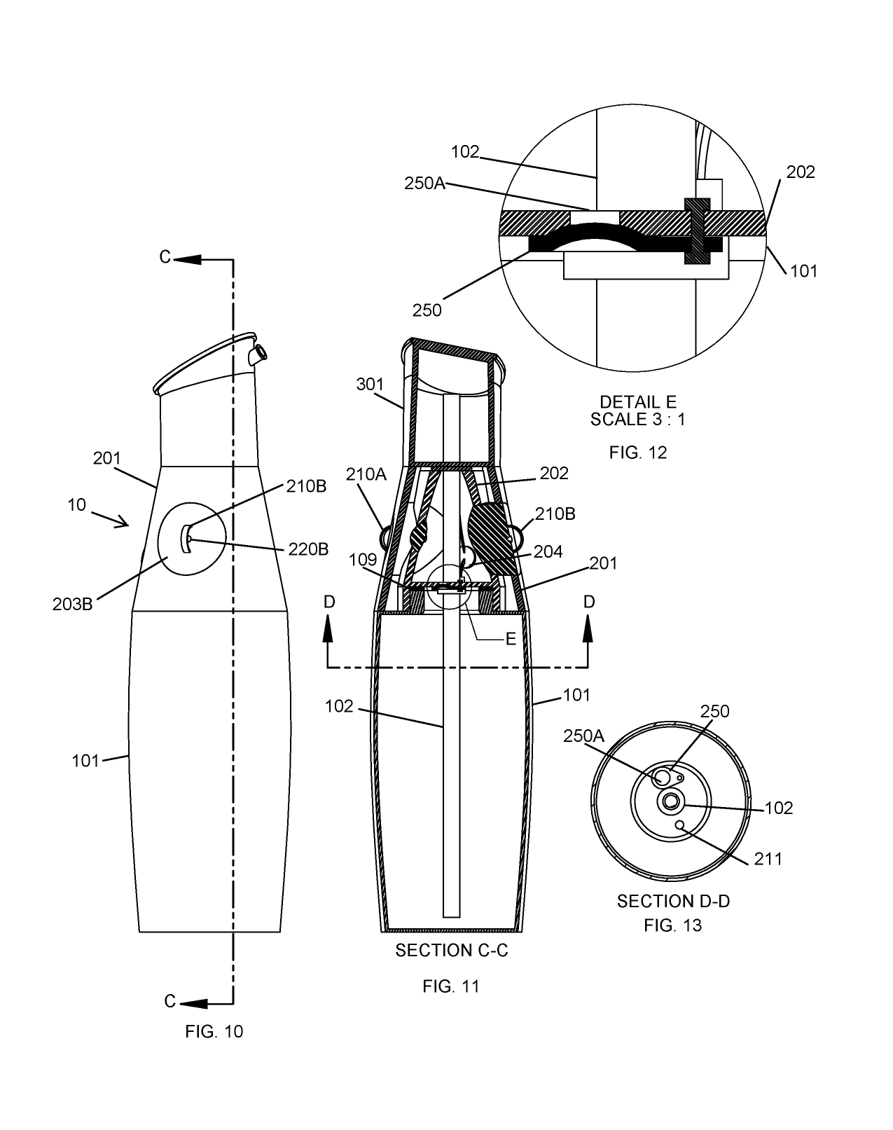

FIG. 10 shows a side-left view of the oil bottle with measuring receptacle 10 with at least one flexible flap 203B with at least one orifice 220B and a loop 210B. The loop 210B can be activated by a user, by pulling the at least one flexible flap 203B outward from the oil bottle 10 to depressurize the second chamber 201, which in turn depressurizes the first chamber 101 by way of the two way valve 210 and allows liquid to re-enter the first chamber 101.

FIG. 11 shows a cutaway side view along plane-C-C of the oil bottle with measuring receptacle 10, first chamber 101, second chamber 201, and third chamber 301. A hollow tube 102 traverses the interior of the oil bottle 10. The hollow tube 102 has at least one orifice at the dorsal end and at least one orifice at the proximal end. The second chamber 201 has an interior chamber created by inner second chamber 202. An air gap separates the wall of the second chamber 201 and the inner second chamber 202. In an alternative embodiment, where the second chamber 201 and first chamber 101 are a single chamber there is no inner second chamber 202 for the second chamber 201. Flexible portions 203A, 203B are connected to the sides of the second chamber 201 and inner second chamber 202. In this embodiment there are two flexible portions 203A, 203B. However, in other conceived embodiments there can be one or more flexible portions. These flexible portions 203A, 203B function as diaphragms and when pressed inward towards the center of the second chamber 201, increase the air pressure in the second chamber 201 and first chamber 101. The flexible portions 203A, 203B have loops 210A, 210B that a user can pull on to decrease air pressure in the first chamber 101 and second chamber 201. In other conceived embodiments these loops can be knobs, buttons, hooks, or other protrusions that a user can easily hold to pull the flexible portions 203A, 203B outward and decrease pressure in the first chamber 101 and second chamber 201, thereby causing the liquid in the tube 102 to re-enter the first chamber 101.

The second chamber 201 also has an actuator 204 which may be flexible or rigid protruding from the second chamber 201 or otherwise easily able to be activated by a user. A flexible gasket 109 seals the first chamber 101 to the second chamber 201 and second inner chamber 202.

FIG. 12 shows Detail E from FIG. 11 of a concave duck valve, flap valve, and/or concave diaphragm valve 250 between the first chamber 101 and second inner chamber 202 of the oil bottle with measuring receptacle 10. When the flexible flaps 203A, 203B (as seen in FIG. 11) are pushed inward, air in, the second inner chamber 202 enters the first chamber 101 via a concave orifice 250A with a second inner chamber wall 202. Concave duckbill valve 250 prevents the air pressure in the first chamber 101 from depressurizing. When the air pressure in the first chamber 101 builds up, it forces the liquid in the first chamber 101 to enter up into the hollow tube 102. In a preferred embodiment the valve between the first chamber 101 and second inner chamber 202 is a concave duck bill valve 250. However in other conceived embodiments the valve 250 may be a flap, convex, butterfly, diaphragm, or other valve type mechanism.

FIG. 13 shows a bottom section view along plane D-D of the juncture between the first chamber 101 and second chamber 201 of the oil bottle with measuring receptacle 10. The hollow tube 102 capable of containing a liquid traverses the center of the oil bottle 10. In other conceived embodiments, the tube 102 may be located off-center or along the perimeter. At one side is an orifice 250A capable of allowing air from the second chamber 201 to enter and pressurize the first chamber 101 via a valve 250. A stopper 211 connected to an actuator (as seen in FIG. 4) allows for pressurization and depressurization of the first chamber 101.

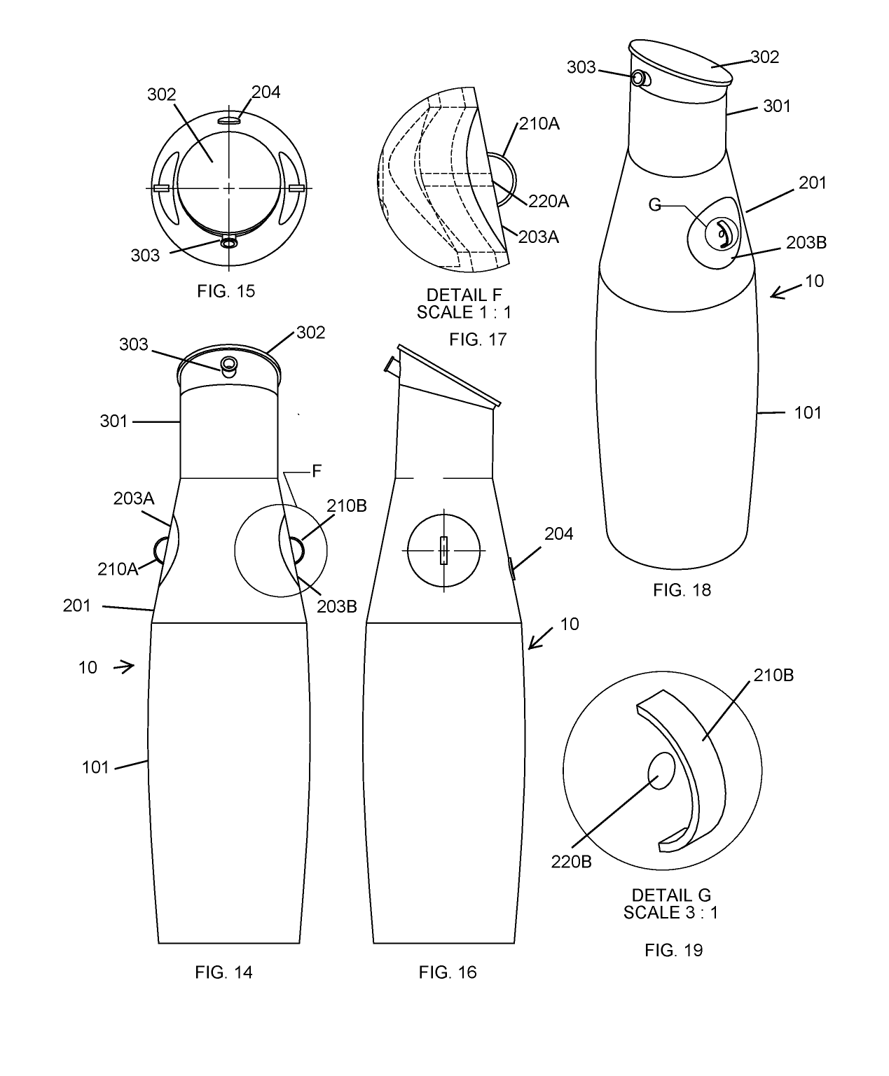

FIG. 14 shows a front view of the oil bottle with measuring receptacle 10 with loops 210A, 2101B on the flexible flaps 203A, 203B with Detail F. The oil bottle 10 has a first chamber 101, second chamber 201, and third chamber 301. The third chamber 301 having a flexible cap 302 that may be entirely removed and reattached. An orifice 303 on the side of the third chamber 301 can dispense the liquid in the oil bottle 10.

FIG. 15 shows a top view of the oil bottle with measuring receptacle (as seen in FIG. 14). The third chamber has a flexible and deformable cap 302 that may be entirely removed and reattached and an orifice 303 on the side of the third chamber 301 can dispense the liquid in the oil bottle 10. An actuator 204 can be activated to depressurize the third chamber 301 and release liquid back into the first chamber 101 of the oil bottle 10.

FIG. 16 shows a side view of the oil bottle with measuring receptacle 10 with actuator 204 capable of depressurizing the first chamber 101 and third chamber 301.

FIG. 17 shows Detail F, a detailed side view of the flexible flap 203A with an orifice 220A and protrusion 210A for the oil bottle with measuring receptacle 10. To pressurize the oil bottle 10 (as seen in FIG. 3) a user can cover the orifice 220A, optionally with a digit, and push the flexible flap 203A inward. This forces air into the first chamber 101 (as seen in FIG. 3) and displaces the liquid in the first chamber 101. The liquid displaced from the first chamber 101 goes up into the hollow tube 102 and up into the third chamber 301, from which it can be dispensed in a controlled manner via an orifice 303 (as seen in FIG. 3). To easily depressurize the oil bottle 10, a user can pull the protrusion 210A outwards thereby causing the air in the first chamber 101 to exit the oil bottle 10 via the orifice 220A and cause the liquid in the tube 102 and/or third chamber 301 to flow back into the first chamber 101. The protrusion 210A may be any type of loop, knob, button, nib or other type of tag easy for a user to pull on to cause the flexible portion 203A or other type of diaphragm to dispel air out through the orifice 220A.

FIG. 18 shows a perspective view of the oil bottle with measuring receptacle 10 with Detail G. The second chamber 201 has a least one flexible portion 203B with an orifice for pressurizing and depressurizing the first chamber 101 and third chamber 301 of the oil bottle with measuring receptacle 10. The top of the third chamber 301 has a flexible cap 302 that functions as a diaphragm that may be depressed to increase air pressure in the third chamber and dispense the liquid in the third chamber 301 from the at least one orifice 303.

FIG. 19 shows Detail G, a detailed perspective view of the flexible flap 203B with orifice 220B and loop 210B for the oil bottle with measuring receptacle 10 (as seen in FIG. 11).

Although only a few embodiments of the present invention have been described herein, it should be understand that the present invention might be embodied in many other specific forms without departing from the spirit or scope of the invention, including permutations of the currently described embodiments. Therefore, the present examples and embodiments are to be considered as illustrative and not restrictive, and the invention may be modified.

What is claimed:

1. A device capable of dispensing a precise amount of liquid, wherein the device is comprised of a top, a middle, and a bottom chamber, the middle chamber being at least single walled, the top chamber and the middle chamber connected together by a first gasket in a static seal, and the middle chamber and the bottom chamber connected together by a second gasket in a static seal, at least one first valve in between the bottom and middle chambers, the at least one first valve allowing air pressure from the middle chamber to enter the bottom chamber to forcibly displace the liquid in the bottom chamber up into a hollow tube, each chamber having a cavity capable of containing the liquid, the hollow tube traversing the vertical length of the device's interior, the hollow tube having a distal end that terminates in the top chamber and a proximal end that terminates in the bottom chamber, the distal and proximal ends each having at least one orifice, the top chamber having a side orifice capable of allowing the liquid to exit the top chamber, the middle chamber having a least one flexible portion that is capable of being depressed to increase the air pressure in the middle chamber, the at least one flexible portion having at least one orifice, an actuator connected to a stopper that plugs a hole between the middle and bottom chambers that when activated removed the stopped between the middle and bottom chambers and allows air pressure from the bottom chamber to exit the bottom chamber and re-enter the middle chamber.

2. The device according to claim 1, wherein the top chamber has a flexible cap that is removable and can be reattached.

3. The device according to claim 1, wherein: the top chamber has markings capable of measuring an amount of liquid in the top chamber.

4. The device according to claim 1, wherein the device is a rigid body except for the;flexible portion.

5. The device according to claim 1, wherein there are two flexible portions that are capable of being depressed by a human user on the side of the middle chamber, wherein each of the two flexible portions has one orifice that a human digit can fully cover.

6. The device according to claim 1, wherein the at least one first valve is bidirectional.

7. The device according to claim 1, wherein the hollow tube is a solid piece.

8. The device according to claim 1, wherein, the hollow tube is multiple segments that are connected together and sealed at their junctures.

9. The device according to claim 1, wherein the tube portion in the top chamber has an orifice at the bottom that is plugged by a stopper and when activated by an activator, the stopper is removed allows liquid in the tube in the top chamber to drain from the tube and enter the top chamber.

10. The device according to claim 1, wherein the tube portion in the top chamber has an orifice at the bottom that is plugged by a stopper and when activated by an top chamber activator, the stopper is removed allows liquid in the tube in the top chamber to drain from the tube and enter the middle chamber via an orifice at the top of middle chamber that is activated by the top chamber activator.

11. The device according to claim 10, wherein the top chamber activator is a button.

12. The device according to claim 1, wherein all surface have an oliophobic coating.

13. The device according to claim 1, wherein the top chamber has a flexible cap capable of being depressed and increasing air pressure in the top chamber thereby forcibly dispensing the liquid from the side orifice in the top chamber.

14. The device according to claim 1, where all the parts are made out of one of plastic, metal, or composite.

15. The device according to claim 1, wherein the flexible portions have a loop facing outward that a user can pull to decrease pressure in the bottom chamber.

16. The device according to claim 1, wherein the top, middle, and bottom chambers and tube can separate and reattach using a combination of snaps, screws, and threads.

17. The device according to claim 1, wherein an atomizer is connected to the top chamber and can atomize the liquid exiting the top chamber.

18. The device according to claim 1, wherein the middle chamber is at least double walled having an inside and an outside shell separated by a gap.

19. The device according to claim 1, wherein the at least one first valve between bottom and middle chamber is a duckbill valve.

20. The device according to claim 1, wherein the at least one first valve between bottom and middle chamber is a concave duckbill valve.
